(19) United States
(12) Patent Application Publication
(10) Pub. No.: US 2023/0107042 A1
(43) Pub. Date: Apr. 6, 2023

(54) Voltage Stabilizer for Sources with Unacceptable Output Variation

(71) Applicant: LECO Corporation, St. Joseph, MI (US)

(72) Inventors: Jeffrey Melvin, Hartland, WI (US); Ted J. Casper, West Bend, WI (US)

(73) Assignee: LECO Corporation, St. Joseph, MI (US)

(21) Appl. No.: 17/905,917

(22) PCT Filed: Mar. 2, 2021
(86) PCT No.: PCT/US2021/020531

§ 371 Date: Sep. 8, 2022

Related U.S. Application Data
(60) Provisional application No. 62/988,004, filed on Mar. 11, 2020.

(51) Int. Cl. G05F 3/22; G05F 1/575; G05F 1/565

(52) U.S. Cl. CPC G05F 3/222; G05F 1/575; G05F 1/565

(57) ABSTRACT

A voltage stabilizer assembly includes a power supply, a device, and a voltage stabilizer. The device is connected to the power supply, wherein the device performance is affected based on the regulation of its power source. The voltage stabilizer is connected between the device and the power supply. The voltage stabilizer includes a low pass filter connected to an output of the power supply and a buffer receiving its input from the low pass filter, the buffer receiving power from the power supply, and the output of the buffer connected to the device.

### CROSS REFERENCE TO RELATED APPLICATIONS

This patent application is a 371 National Stage entry based on International Application No. PCT/US2021/020531, filed on Mar. 2, 2021, which claims priority to U.S. Provisional Application 62/988,004, filed on Mar. 11, 2020. The disclosures of these prior applications are considered part of the disclosure of this application and are hereby incorporated by reference in their entireties.

### TECHNICAL FIELD

This disclosure relates to systems and methods to stabilize the voltage from a source with unacceptable regulation.

### BACKGROUND

Reducing variation of an output voltage may be beneficial for a variety of systems. As one example, mass spectrometry is a well-recognized tool of analytical chemistry, used for identification and quantitative analysis of various compounds and mixtures. The sensitivity and resolution of such analysis is an important concern for practical use. One of the factors impacting sensitivity and resolution is the voltage delivered to components of a mass spectrometer by one or more power supplies. High voltage power supplies are typically designed to provide a high direct current (DC) voltage output into a constant load. Many of these power supplies have high alternating current (AC) or dynamic load output impedance, limited energy storage for coping with dynamic loads, slow control loops, and high output ripple and noise levels. In some situations, the output voltage variations may be unacceptable from the start, due to tighter requirements than the supply can provide, or may become unacceptable during operation, e.g., due to changes in line voltage, load current, or other concerns. Accordingly, it may be beneficial to reduce the variation of the output voltage.

### SUMMARY

One aspect of the disclosure provides a voltage stabilizer assembly including a power supply, a device, and a voltage stabilizer. The device is connected to the power supply, wherein the device performance is affected based on the regulation of its power source. The voltage stabilizer is connected between the device and the power supply. The voltage stabilizer includes a low pass filter connected to an output of the power supply and a buffer receiving its input from the low pass filter, the buffer receiving power from the power supply, and the output of the buffer connected to the device.

Implementations of the disclosure may include one or more of the following optional features. In some implementations, the voltage stabilizer assembly includes a pulsing device connected between the power supply and the device, the pulsing device configured to receive a voltage from the power supply through the voltage stabilizer and deliver the voltage to the device. The pulsing device may be configured to deliver the voltage to the device at least one frequency.

The voltage stabilizer may include a load filter connected to an output of the power supply. The voltage stabilizer may include a suppressor connected to the buffer, the suppressor configured to provide at least one of over-voltage or reverse-voltage protection.

The power supply may include a high side power supply and a low side power supply. The voltage stabilizer may include a first voltage stabilizer connected to the high side power supply and a second voltage stabilizer connected to the low side power supply. The device may include an electro-optic beam steering device. The device may include a component of a mass spectrometer.

Another aspect of the disclosure provides a circuit for a mass spectrometer, the circuit comprising a power supply, a pulsing device connected to the power supply, the pulsing device configured to deliver voltage to an ion steering device, and a voltage stabilizer connected between the pulsing device and the power supply, the voltage stabilizer configured to reduce voltage variation delivered to the ion steering device through the pulsing device. This aspect may include one or more of the following optional features.

The voltage stabilizer may include a load filter connected to an output of the power supply. The voltage stabilizer may include a low pass filter connected to an output of the power supply. The voltage stabilizer may include a buffer receiving its input from the low pass filter, the buffer receiving power from the power supply, and the output of the buffer connected to the device. The circuit may include a suppressor connected to the buffer, the suppressor configured to provide at least one of over-voltage or reverse-voltage protection.

The power supply may include a high side power supply and a low side power supply. The voltage stabilizer may include a first voltage stabilizer connected to the high side power supply and a second voltage stabilizer connected to the low side power supply.

Another aspect of the disclosure provides a method for delivering voltage to a device, the method comprising providing a power supply, providing a device connected to the power supply, connecting a voltage stabilizer between the power supply and the device, the voltage stabilizer including a low pass filter connected to an output of the power supply and a buffer receiving its input from the low pass filter, the buffer receiving power from the power supply, and the output of the buffer connected to the device, reducing, by the voltage stabilizer, variation of a voltage received from the power supply, and delivering, by the voltage stabilizer, the reduced-variation voltage to the device. This aspect may include one or more of the following optional features.

The voltage stabilizer may include a load filter connected to an output of the power supply. The method may include providing a suppressor connected to the buffer, the suppressor configured to provide at least one of over-voltage or reverse-voltage protection.

The power supply may include a high side power supply and a low side power supply. The voltage stabilizer may include a first voltage stabilizer connected to the high side power supply and a second voltage stabilizer connected to the low side power supply. The device may include an electro-optic beam steering device. The device may include a component of a mass spectrometer.

The power supply may provide a positive output voltage, a negative output voltage, or an output that can be either positive or negative. Changes to the voltage stabilizer circuit may be required for each instance.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is an exemplary prior art power supply circuit;

FIG. 2 is a schematic representation of an exemplary multi-reflecting time-of-flight mass spectrometer (MR-TOF MS) and a power supply circuit, in accordance with the principles of the present disclosure;

FIG. 3 is a schematic representation of the power supply circuit of FIG. 2;

FIG. 4A is a first exemplary schematic representation of a voltage stabilizer of the power supply circuit of FIG. 3;

FIG. 4B is a second exemplary schematic representation of a voltage stabilizer of the power supply circuit of FIG. 3;

FIG. 4C is a third exemplary schematic representation of a voltage stabilizer of the power supply circuit of FIG. 3;

FIG. 5A is a circuit diagram of the voltage stabilizer of FIG. 4A;

FIG. 5B is a circuit diagram of the voltage stabilizer of FIG. 4B;

FIG. 5C is a circuit diagram of the voltage stabilizer of FIG. 4C;

FIG. 5D is a circuit diagram of the voltage stabilizer of FIG. 4B configured for use with a negative reference level, allowing the output of the voltage stabilizer to operate at or below the ground voltage;

FIG. 5E is a circuit diagram of the voltage stabilizer of FIG. 4B configured for use with a negative power supply;

FIG. 5F is a circuit diagram of the voltage stabilizer of FIG. 4B configured for use with a power supply that can output either positive or negative voltage;

FIG. 6 is a flowchart representing a method for delivering power to an electro-optic beam steering device, in accordance with the principles of the present disclosure;

FIG. 7 is a graphical representation illustrating a power supply output, a pulser output, and a voltage stabilizer output implementing the power supply circuit of FIG. 3 under a first set of conditions; and

FIG. 8 is a graphical representation illustrating a power supply output, a pulser output, and a voltage stabilizer output implementing the power supply circuit of FIG. 3 under a second set of conditions.

Like reference symbols in the various drawings indicate like elements.

### DETAILED DESCRIPTION

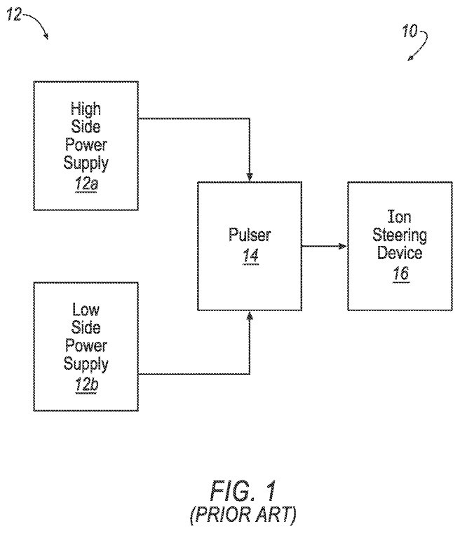

Referring to FIG. 1, a prior art power supply circuit 10 is generally shown. The power supply circuit 10 includes a power supply 12 having a high side power supply 12a and a low side power supply 12b, a pulser 14, and an ion steering device 16. The power supply circuit 10 is implemented in or connected to a prior art spectrometer (not shown). A voltage delivered from the power supply 12 through the pulser 14 and to the ion steering device 16 may be rapidly changed to affect the steering of ion packets by the ion steering device 16 at specific times. This change in voltage application may be accomplished by the pulser 14 to switch between two separate precise voltage inputs.

The pulser 14 may include sufficient internal capacitance to charge (or discharge) the ion steering device 16 with a small drop (or rise) in applied voltage. When the pulser 14 is switched at a continuous rate, the precise voltage inputs, provided by the power supply 12, may each experience a constant load as the power supply 12 replenishes the charge on the internal capacitances of the pulser 14. When the pulser 14 is switched at a variable rate the load presented to the power supply 12 may also vary. This load change may cause voltage variation from the power supply 12 due to the output impedance, minimal energy storage and slow control loop of the power supply 12. While the average voltage may be accurate, as ensured by the control loop of the power supply 12, the variable rate of the pulser 14 may result in voltage variation at the input to the pulser 14. Due to the precision and sensitivity requirements of mass spectrometry analysis, this voltage variation may be unacceptable.

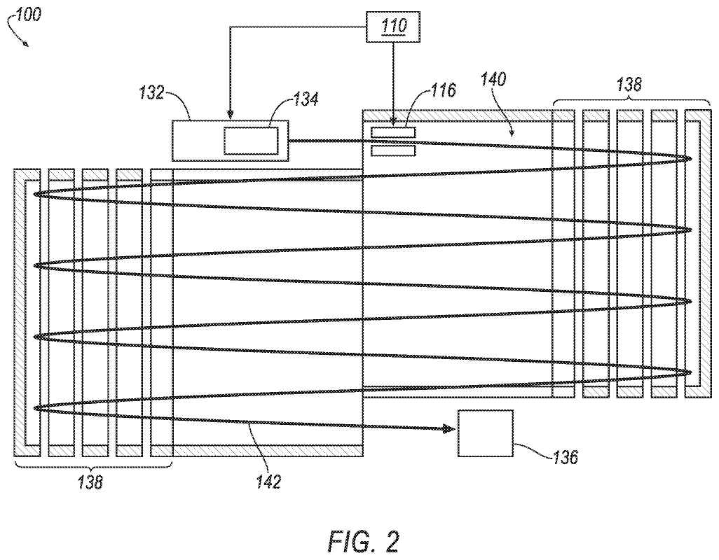

Referring to FIG. 2, a mass spectrometer 100 is generally shown. While the mass spectrometer 100 is generally illustrated in FIG. 2 as being a multi-reflecting time-of-flight mass spectrometer (MR-TOF MS), it is to be understood that the mass spectrometer 100 may be any suitable device or mass analyzer, including, but not limited to, a sector field mass spectrometer, a quadrupole mass spectrometer, a magnetic sector mass spectrometer, an electrostatic sector mass spectrometer, a quadrupole ion trap mass spectrometer, an ion cyclotron resonance, etc. In some implementations, the mass spectrometer 100 may be combined with any suitable separation technique, including, but not limited to, gas chromatography, liquid chromatography, capillary electrophoresis, ion mobility, etc.

The mass spectrometer 100 includes a power supply circuit 110 which may be incorporated in or connected to the mass spectrometer 100. It should be understood that the mass spectrometer 100 described herein is used for exemplary purposes only and that the power supply circuit 110 may be incorporated in or connected to any suitable system or device. The mass spectrometer 100 includes an ion source 132 and an accelerator 134 which may be incorporated in or connected to the ion source 132. The mass spectrometer 100 includes an ion receiver or detector 136 and a set of two gridless ion mirrors 138 parallel to each other and substantially elongated in a shift direction. A field-free space 140 is disposed between the ion mirrors 138 and a set of optional lenses (not shown) may be positioned in the field-free space 140 between the ion mirrors 138 to provide periodic focusing of the ion packets. The elements of the mass spectrometer 100 are arranged to provide a folded ion path 142 between the ion source 132 and the ion receiver 136, the ion path 142 including multiple reflections between the ion mirrors 138 along the shift direction.

The mass spectrometer 100 includes an ion steering device 116 and shifting of the ion packets may be arranged by slightly tilting, mechanically or electronically, the incoming ion packets from the ion source 132 by the ion steering device 116. The power supply circuit 110 may be electrically connected to the ion steering device 116 and the ion source 132, as well as any other suitable component of the mass spectrometer 100. The ion steering device 116 may have a precise voltage applied to it in order to accurately steer or shift the ion packets. In some embodiments, the ion steering device 116 may have any suitable voltage applied to it, such as a relatively high voltage DC power supply that has excessive output ripple due to load variations and/or high inherent ripple voltage in the DC power supply itself.

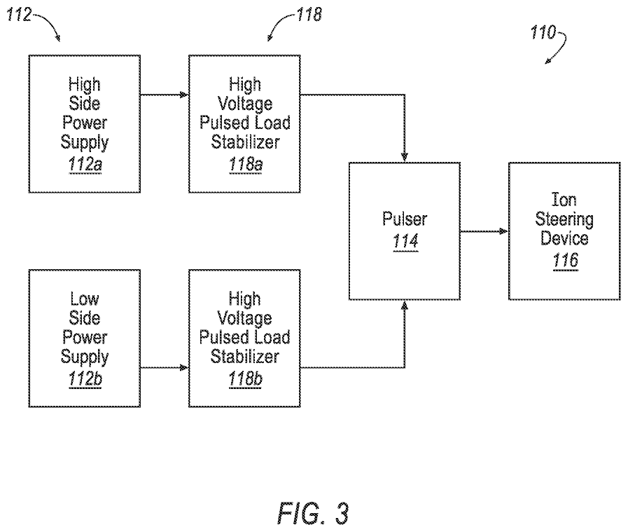

Referring to FIG. 3, the power supply circuit 110 may be generally shown. The power supply circuit 110 includes a power supply 112, a voltage stabilizer 118, a pulsing device or pulser 114, and the ion steering device 116. The power supply 112, the pulser 114, and the ion steering device 116 may be substantially similar to the power supply 12, the pulser 14, and the ion steering device 16, respectively, described above.

The power supply 112 may be any suitable power supply, such as power derived from a conventional electrical outlet, a battery, etc. The power supply 112 may include one or more power supplies 112, such as a high side power supply 112a and a low side power supply 112b. Similarly, the voltage stabilizer 118 may include a high side voltage stabilizer 118a connected to the high side power supply 112a and a low side voltage stabilizer 118b connected to the low side power supply 112b. The high side power supply 112a has a greater potential than the low side power supply 112b.

The high side power supply 112a and the low side power supply 112b may each provide a positive output voltage, a negative output voltage, or an output that can be either positive or negative. As one example, the high side power supply 112a and the low side power supply 112b may both provide a positive output voltage, with the potential of the high side power supply 112 being greater than the potential of the low side power supply 112b. As another example, the high side power supply 112a may provide a positive output voltage and the low side power supply 112b may provide a negative output voltage, with the potential of the high side power supply 112 being greater than the potential of the low side power supply 112b.

The high side power supply 112a may include one or more high side power supplies 112a and the low side power supply 112b may include one or more low side power supplies 112b. As one example, the high side power supply 112a may include two high side power supplies 112a, and the low side power supply 112b may include two low side power supplies 112b. In implementations where there are multiple high side power supplies 112a and multiple low side power supplies 112b, there may be a corresponding number of voltage stabilizers 118 equal to the amount of high side power supplies 112a and low side power supplies 112b, each of the voltage stabilizers 118 being connected to each of the high side power supplies 112a and low side power supplies 112b. In some implementations where there are multiple high side power supplies 112a and multiple low side power supplies 112b, the voltage stabilizers 118 may be connected to some, but not all, of the high side power supplies 112a and low side power supplies 112b. For example, if there were three high side power supplies 112a and three low side power supplies 112b, there may be four voltage stabilizers 118 connected to two of the high side power supplies 112a and two of the low side power supplies 112b, respectively, with one of the high side power supplies 112a and one of the low side power supplies 112b not being connected to a voltage stabilizer 118. Continuing with the example, the high side power supply 112a and the low side power supply 112b that are not connected to a voltage stabilizer 118 may instead be connected to any other suitable component, such as a switch, a filter, etc.

The voltage stabilizer 118 is connected to the pulser 114 which is connected to the ion steering device 116. The pulser 114 may deliver voltage from the power supply 112, through the voltage stabilizer 118, to the ion steering device 116 at a first frequency and possibly at least one second frequency different than the first frequency. The ion steering device 116 may be any suitable ion steering device, such as an electrostatic plate, a drift tube, etc. The frequency and voltage which the pulser 114 delivers to the ion steering device 116 may determine, at least in part, the amount of shift the ion steering device imparts on the ion packets.

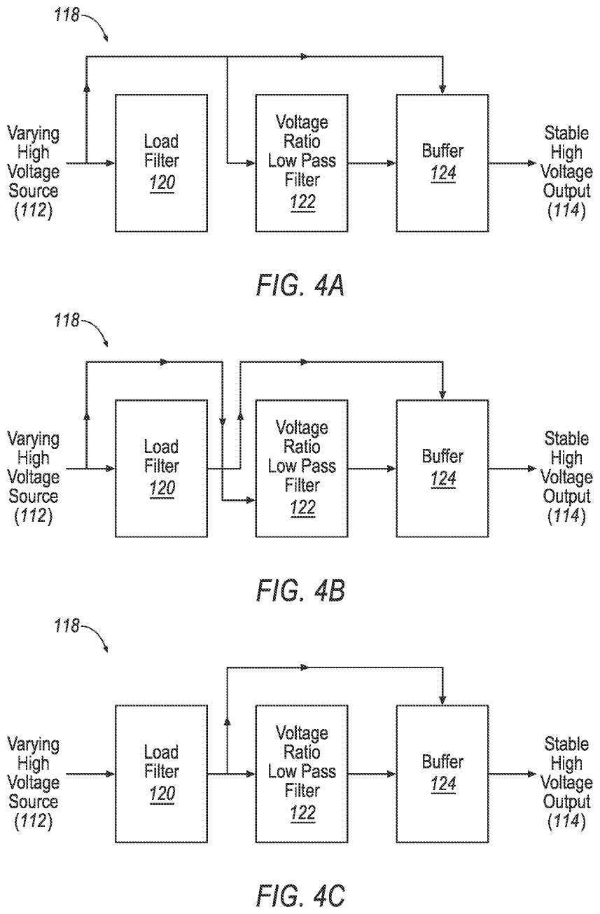

Referring to FIG. 4A, a first exemplary configuration of the voltage stabilizer 118 may include a load filter 120 connected to the output of the power supply 112, a voltage ratio and low pass filter 122 connected to the output of the power supply 112, and a buffer 124 connected to the output of the power supply 112, the output of the voltage ratio and low pass filter 122, and the input of the pulser 114, as described in greater detail below. Referring to FIG. 4B, a second exemplary configuration of the voltage stabilizer 118 may include the load filter 120 connected to the output of the power supply 112, the voltage ratio and low pass filter 122 connected to the output of the power supply 112, and the buffer 124 connected to the output of the load filter 120, the output of the voltage ratio and low pass filter 122, and the input of the pulser 114, as described in greater detail below. Referring to FIG. 4C, a third exemplary configuration of the voltage stabilizer 118 may include the load filter 120 connected to the output of the power supply 112, the voltage ratio and low pass filter 122 connected to the output of the load filter 120, and the buffer 124 connected to the output of the load filter 120, the output of the voltage ratio and low pass filter 122, and the input of the pulser 114, as described in greater detail below. In each of the exemplary configurations shown in FIGS. 4A-4C, the load filter 120 may be omitted, for example, if the power supply 112 can sufficiently work into the impedance of the buffer 124.

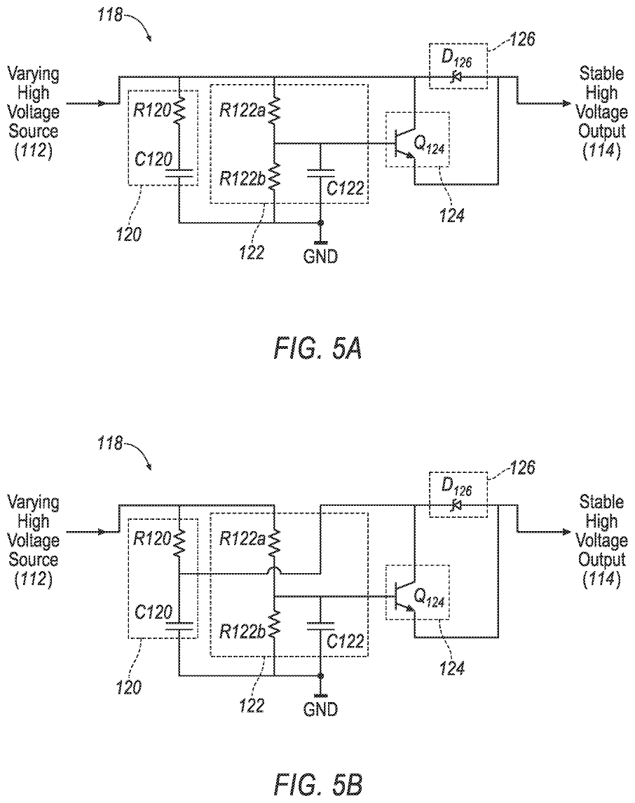

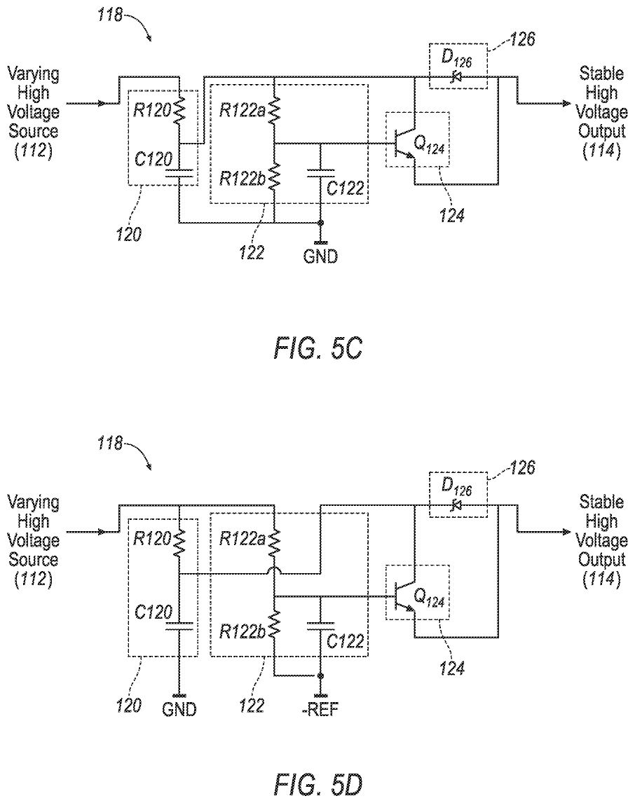

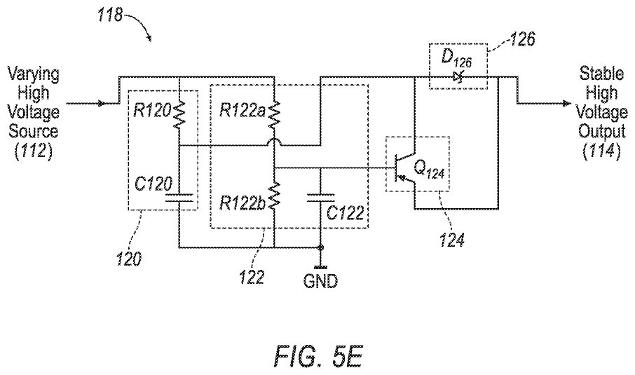

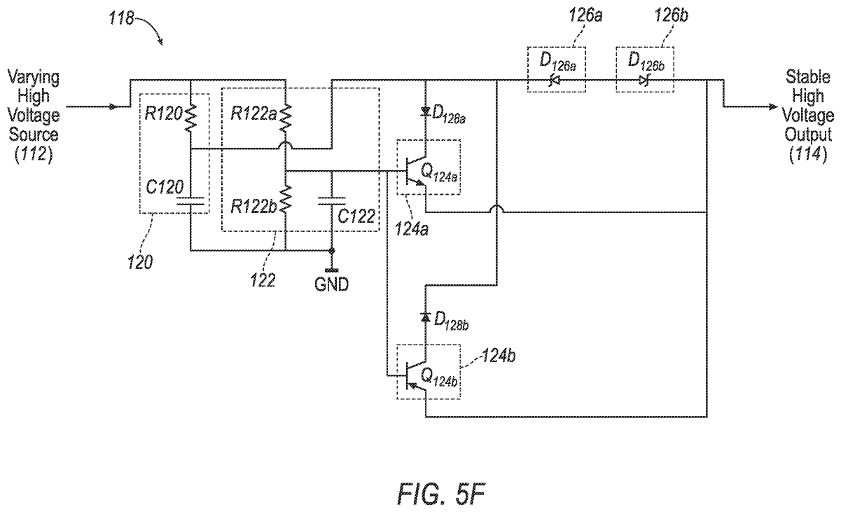

Referring to FIG. 5A, the electrical components of the first exemplary configuration of the voltage stabilizer 118 (FIG. 4A) are generally shown. The load filter 120 includes a resistor R₁₂₀ and a capacitor C₁₂₀ connected in series. The voltage ratio and low pass filter 122 creates a voltage ratio using resistors R₁₂₂ₐ, R_{122b} connected in series and the low pass filter 122 using capacitor C₁₂₂ in parallel with the resistor R_{122b}. The resistor R_{122b} may provide a local discharge path for the capacitor C₁₂₂. The buffer 124 includes a transistor Q₁₂₄ which may operate as an emitter-follower. In some implementations, the transistor Q₁₂₄ may be an NPN transistor. The voltage stabilizer 118 may include over-voltage protection and/or reverse-voltage protection 126 for the buffer 124 by way of a suppressor D₁₂₆. The suppressor D₁₂₆ may provide a charge/discharge path for any capacitors beyond the output of the voltage stabilizer 118, for example, any capacitors in the pulser 114. In some implementations, for example if there was a negative supply, the transistor Q₁₂₄ may be a PNP transistor and the direction of the suppressor D₁₂₆ may be reversed.

The output of the voltage ratio and low pass filter 122 is an input control to the buffer 124. The buffer 124 is powered by the power supply 112. The variation from the power supply 112 plus a buffer headroom voltage may appear across the buffer 124. The variation at an output of the buffer 124 may be the sum of the variation of the voltage ratio and low pass filter 122 plus an output current of the buffer 124 multiplied by an output impedance of the buffer 124. In some implementations, the buffer 124 will present a negative impedance load to the power supply 112, which will result in higher variation in the output of the power supply 112. The presence of the load filter 120 may help to reduce output variation of the power supply 112 when the buffer 124 presents the negative impedance.

FIG. 5B illustrates the electrical components of the second exemplary configuration of the voltage stabilizer 118 (FIG. 4B), and FIG. 5C illustrates the electrical components of the third exemplary configuration of the voltage stabilizer 118 (FIG. 4C). FIG. 5D illustrates the electrical components of the second exemplary configuration of the voltage stabilizer 118 (FIG. 4B) where the voltage ratio and low pass filter is connected to a negative reference, allowing the voltage stabilizer output to operate at or below the ground level. In this configuration the ripple and noise on the reference will appear at the output. FIG. 5E illustrates the electrical components of the second exemplary configuration of the voltage stabilizer 118 (FIG. 4B) where the transistor Q₁₂₄ is a PNP transistor and the direction of the suppressor D₁₂₆ is reversed to be used with a negative power supply 112. FIG. 5F illustrates the electrical components of the second exemplary configuration of the voltage stabilizer 118 (FIG. 4B) where two transistors Q₁₂₄ₐ, Q_{124b}, an NPN transistor and a PNP transistor, respectively, two suppressors D₁₂₆ₐ, D_{126b}, and two diodes D₁₂₈ₐ, D_{128b}, allow operation with a bipolar power supply 112. The electrical components of the voltage stabilizer described above are meant as exemplary only, and it is to be understood that any suitable electrical components may be used to accomplish the same or similar results.

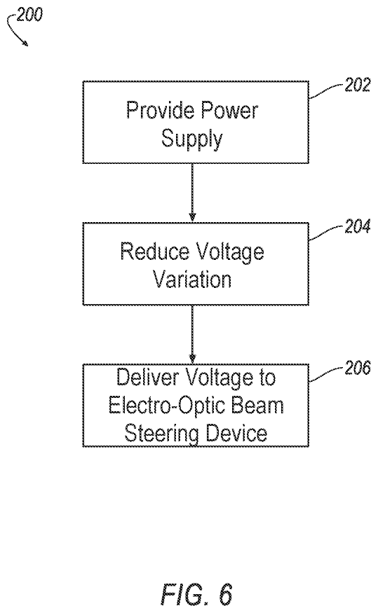

Referring to FIG. 6, a method 200 for delivering voltage to the electro-optic beam steering device 116 may include the steps of providing a power supply 202, reducing the voltage variation 204 through the use of the voltage stabilizer 118, and delivering voltage 206 to the electro-optic beam steering device 116 via the pulser 114. The output of the power supply 112 may be filtered by the voltage ratio and low pass filter 122 at a frequency low enough to provide the required output precision. An input impedance of the voltage ratio and low pass filter 122 may be high enough to have little to no effect on stability of the power supply 112. An output impedance of the voltage ratio and low pass filter 122 may be low enough to ensure the output voltage is sufficiently stable while experiencing a changing load. An output of the voltage ratio and low pass filter 122 may be a ratio, a fixed amount, or a combination of the two less than an average output voltage of the power supply 112.

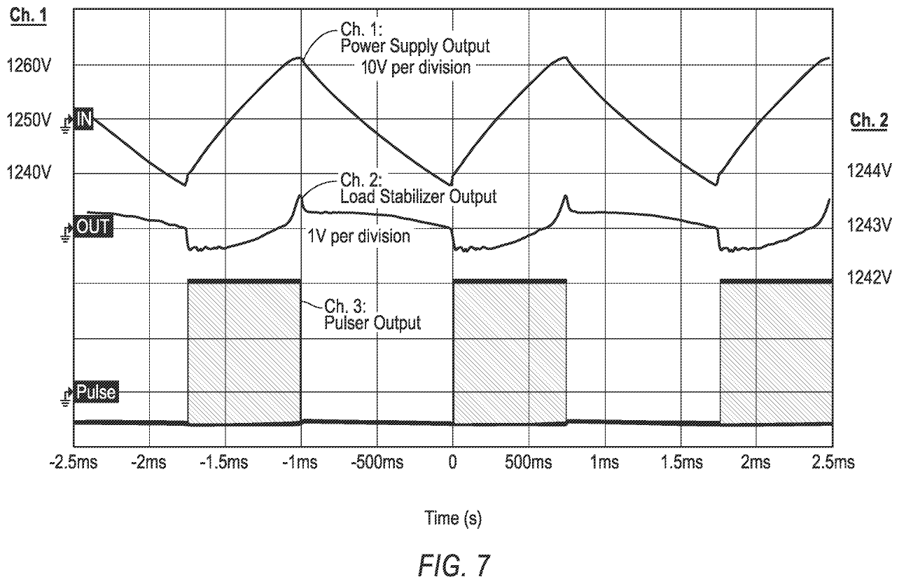

Referring to FIG. 7, a graph illustrating output voltage variations for the power supply 112 (Channel 1), the voltage stabilizer 118 (Channel 2), and the pulser 114 (Channel 3) under a first set of conditions are shown. As can be seen, the output voltage variation of the power supply 112 is over 20 volts peak-to-peak while the output voltage variation of the voltage stabilizer 118 is about 1 volt peak-to-peak. Note that the waveform of Channel 1 and the waveform of Channel 2 are shown at different scale factors.

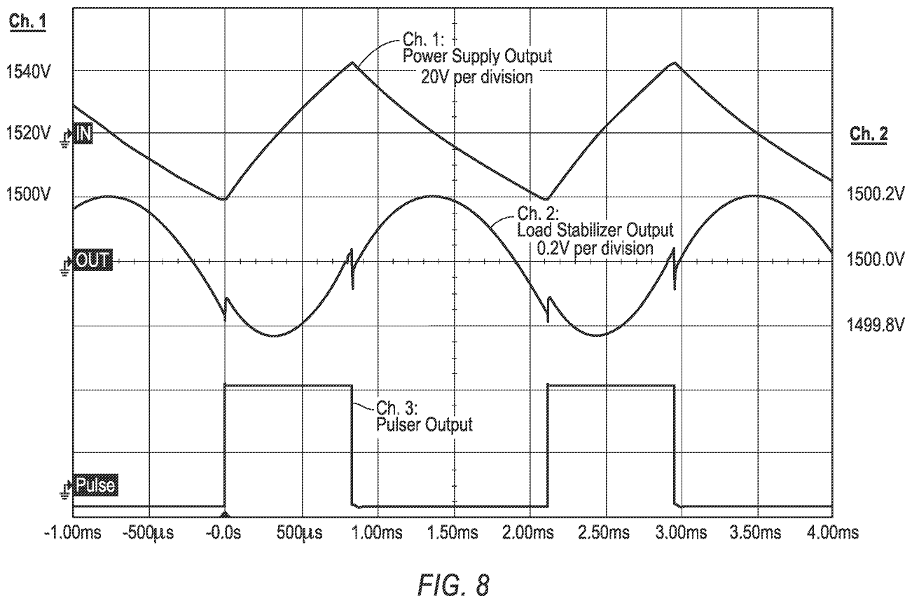

Referring to FIG. 8, a graph illustrating output voltage variations for the power supply 112 (Channel 1), the voltage stabilizer 118 (Channel 2), and the pulser 114 (Channel 3) under a second set of conditions are shown. As can be seen, the output voltage variation of the power supply 112 is over 40V peak-to-peak while the output voltage variation of the voltage stabilizer 118 is about 0.4V peak-to-peak. Note that the waveform of Channel 1 and the waveform of Channel 2 are shown at different scale factors.

While the voltage stabilizer 118 of the power supply circuit 110 has been described above as being incorporated in a mass spectrometry system, it should be understood that the voltage stabilizer 118 may be incorporated in other applications, as suitable.

As a first example, the voltage stabilizer 118 may be configured to smooth power supply output noise and ripple. For example, switching power supplies have inherent noise and ripple on their outputs. High voltage or low cost supplies oftentimes have insufficient output filtering. Setting the power supply output to a higher voltage and adding the voltage stabilizer 118 may reduce the ripple 40 dB and reduce the noise even further, as it has much higher frequency content.

As a second example, the voltage stabilizer 118 may be configured for variable frequency loading. For example, if a power supply is connected to a system where its load is rapidly switched between two values or it is required to repetitively charge or discharge a capacitance, the voltage output can vary. The degree to which variation occurs is dependent on the load response of the supply. This variation may be unacceptable for the system. In this example, the voltage stabilizer 118 may be added between the power supply and the device to reduce the variation.

As a third example, the voltage stabilizer 118 may be configured for discrete load switching. For example, if a power supply is connected to a system where loads are rapidly switched in and out of circuit the voltage output can vary. The degree to which variation occurs is dependent on the load regulation and load response of the supply. This variation may cause unacceptable operation of a device that remains connected while others are switched in and out of circuit. In this example, the voltage stabilizer 118 may be added between the power supply and the devices to reduce the variation.

As a fourth example, the voltage stabilizer 118 may be configured for electro-optic beam steering. For example, electro-optic beam steering is a method of steering light, radar, ions and other beams electronically. Doing so quickly implies rapid voltage or load changes which can result in variation of the power supply output. If the steering must be both quick and accurate this variation may be unacceptable. In this example, the voltage stabilizer 118 may be added between the power supply and the electro-optic beam steering device.

As a fifth example, the voltage stabilizer 118 may be configured for power supply design. For example, the voltage stabilizer 118 may be added within the power supply to ensure it meets stringent output requirements while also closing the DC loop around the stabilizer. This allows the power supply to have significantly improved specifications with a minimal increase in cost, size, and weight of the supply.

The voltage stabilizer 118 may be configured to be applied to or incorporated in the following non-exhaustive list of examples: medical imaging, x-ray systems, semiconductor test, pulsed electrophoresis, pulsed electron beam generation, pulsed ion beam generation, pulsed LASER generation, pulsed LIDAR generation, pulsed RADAR generation, electron microscopy, optical spectroscopy, mass spectroscopy, beam steering, particle acceleration, low cost power supply, and high voltage power supply.

Various implementations of the systems and techniques described herein may be realized in digital electronic and/or optical circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Further examples consistent with the present teachings described herein are set out in the following numbered clauses:

Clause 1: A voltage stabilizer assembly comprising: a power supply; a device connected to the power supply, wherein the device performance is affected based on the regulation of its power source; and a voltage stabilizer connected between the device and the power supply, the voltage stabilizer including a low pass filter connected to an output of the power supply and a buffer receiving its input from the low pass filter, the buffer receiving power from the power supply, and the output of the buffer connected to the device.

Clause 2: The voltage stabilizer assembly of clause 1, further comprising a pulsing device connected between the power supply and the device, the pulsing device configured to receive a voltage from the power supply through the voltage stabilizer and deliver the voltage to the device.

Clause 3: The voltage stabilizer assembly of clause 2, wherein the pulsing device is configured to deliver the voltage to the device at least one frequency.

Clause 4: The voltage stabilizer assembly of any of clauses 1 through 3, wherein the voltage stabilizer includes a load filter connected to an output of the power supply.

Clause 5: The voltage stabilizer assembly of any of clauses 1 through 4, further comprising a suppressor connected to the buffer, the suppressor configured to provide at least one of over-voltage or reverse-voltage protection.

Clause 6: The voltage stabilizer assembly of any of clauses 1 through 5, wherein the power supply includes a high side power supply and a low side power supply, and wherein the voltage stabilizer includes a first voltage stabilizer connected to the high side power supply and a second voltage stabilizer connected to the low side power supply.

Clause 7: The voltage stabilizer assembly of any of clauses 1 through 6, wherein the device includes an electro-optic beam steering device.

Clause 8: The voltage stabilizer assembly of any of clauses 1 through 7, wherein the device includes a component of a mass spectrometer.

Clause 9: A circuit for a mass spectrometer, the circuit comprising: a power supply; a pulsing device connected to the power supply, the pulsing device configured to deliver voltage to an ion steering device; and a voltage stabilizer connected between the pulsing device and the power supply, the voltage stabilizer configured to reduce voltage variation delivered to the ion steering device through the pulsing device.

Clause 10: The circuit of clause 9, wherein the voltage stabilizer includes a load filter connected to an output of the power supply.

Clause 11: The circuit of any of clauses 9 through 10, wherein the voltage stabilizer includes a low pass filter connected to an output of the power supply.

Clause 12: The circuit of clause 11, wherein the voltage stabilizer includes a buffer receiving its input from the low pass filter, the buffer receiving power from the power supply, and the output of the buffer connected to the pulsing device.

Clause 13: The circuit of clause 12, further comprising a suppressor connected to the buffer, the suppressor configured to provide at least one of over-voltage or reverse-voltage protection.

Clause 14: The circuit of any of clauses 9 through 13, wherein the power supply includes a high side power supply and a low side power supply, and wherein the voltage stabilizer includes a first voltage stabilizer connected to the high side power supply and a second voltage stabilizer connected to the low side power supply.

Clause 15: A method for delivering voltage to a device, the method comprising: providing a power supply; providing a device connected to the power supply; connecting a voltage stabilizer between the power supply and the device, the voltage stabilizer including a low pass filter connected to an output of the power supply and a buffer receiving its input from the low pass filter, the buffer receiving power from the power supply, and the output of the buffer connected to the device; reducing, by the voltage stabilizer, variation of a voltage received from the power supply; and delivering, by the voltage stabilizer, the reduced-variation voltage to the device.

Clause 16: The method of clause 15, wherein the voltage stabilizer includes a load filter connected to an output of the power supply.

Clause 17: The method of any of clauses 15 through 16, further comprising providing a suppressor connected to the buffer, the suppressor configured to provide at least one of over-voltage or reverse-voltage protection.

Clause 18: The method of any of clauses 15 through 17, wherein the power supply includes a high side power supply and a low side power supply, and wherein the voltage stabilizer includes a first voltage stabilizer connected to the high side power supply and a second voltage stabilizer connected to the low side power supply.

Clause 19: The method of any of clauses 15 through 18, wherein the device is a component of a mass spectrometer.

Clause 20: The method of any of clauses 15 through 19, wherein the device includes an electro-optic beam steering device.

A number of implementations have been described. Nevertheless, it will be understood that various modifications may be made without departing from the spirit and scope of the disclosure. Accordingly, other implementations are within the scope of the following claims.

1. A voltage stabilizer assembly comprising:
a power supply;
a device connected to the power supply, wherein the device performance is affected based on the regulation of the power supply; and
a voltage stabilizer connected between the device and the power supply, the voltage stabilizer including a low pass filter connected to an output of the power supply and a buffer receiving an input from the low pass filter, the buffer receiving power from the power supply, and the output of the buffer connected to the device.

2. The voltage stabilizer assembly of claim 1, further comprising a pulsing device connected between the power supply and the device, the pulsing device configured to receive a voltage from the power supply through the voltage stabilizer and deliver the voltage to the device.

3. The voltage stabilizer assembly of claim 2, wherein the pulsing device is configured to deliver the voltage to the device at least one frequency.

4. The voltage stabilizer assembly of claim 1, wherein the voltage stabilizer includes a load filter connected to an output of the power supply.

5. The voltage stabilizer assembly of claim 1, further comprising a suppressor connected to the buffer, the suppressor configured to provide at least one of over-voltage or reverse-voltage protection.

6. The voltage stabilizer assembly of claim 1, wherein the power supply includes a high side power supply and a low side power supply, and wherein the voltage stabilizer includes a first voltage stabilizer connected to the high side power supply and a second voltage stabilizer connected to the low side power supply.

7. The voltage stabilizer assembly of claim 1, wherein the device includes an electro-optic beam steering device.

8. The voltage stabilizer assembly of claim 1, wherein the device includes a component of a mass spectrometer.

9. A circuit for a mass spectrometer, the circuit comprising:
a power supply;
a pulsing device connected to the power supply, the pulsing device configured to deliver voltage to an ion steering device; and
a voltage stabilizer connected between the pulsing device and the power supply, the voltage stabilizer configured to reduce voltage variation delivered to the ion steering device through the pulsing device.

10. The circuit of claim 9, wherein the voltage stabilizer includes a load filter connected to an output of the power supply.

11. The circuit of claim 9, wherein the voltage stabilizer includes a low pass filter connected to an output of the power supply.

12. The circuit of claim 11, wherein the voltage stabilizer includes a buffer receiving an input from the low pass filter, the buffer receiving power from the power supply, and the output of the buffer connected to the pulsing device.

13. The circuit of claim 12, further comprising a suppressor connected to the buffer, the suppressor configured to provide at least one of over-voltage or reverse-voltage protection.

14. The circuit of claim 9, wherein the power supply includes a high side power supply and a low side power supply, and wherein the voltage stabilizer includes a first voltage stabilizer connected to the high side power supply and a second voltage stabilizer connected to the low side power supply.

15. A method for delivering voltage to a device, the method comprising:
providing a power supply;
providing a device connected to the power supply;
connecting a voltage stabilizer between the power supply and the device, the voltage stabilizer including a low pass filter connected to an output of the power supply and a buffer receiving an input from the low pass filter, the buffer receiving power from the power supply, and the output of the buffer connected to the device;
reducing, by the voltage stabilizer, variation of a voltage received from the power supply; and
delivering, by the voltage stabilizer, the reduced-variation voltage to the device.

16. The method of claim 15, wherein the voltage stabilizer includes a load filter connected to an output of the power supply.

17. The method of claim 15, further comprising providing a suppressor connected to the buffer, the suppressor configured to provide at least one of over-voltage or reverse-voltage protection.

18. The method of claim 15, wherein the power supply includes a high side power supply and a low side power supply, and wherein the voltage stabilizer includes a first voltage stabilizer connected to the high side power supply and a second voltage stabilizer connected to the low side power supply.

19. The method of claim 15, wherein the device is a component of a mass spectrometer.

20. The method of claim 15, wherein the device includes an electro-optic beam steering device.
